(19) United States
(12) Patent Application Publication
(10) Pub. No.: US 2025/0389177 A1
(43) Pub. Date: Dec. 25, 2025

(54) Manufacturing Micro-proppant Onsite

(71) Applicant: Chevron U.S.A. Inc., San Ramon, CA (US)

(72) Inventors: Xinghui Liu, Houston, TX (US); Brent Austin Kebert, The Woodlands, TX (US); Darren Raphael McDuff, Houston, TX (US); George Michael Lilly, El Prado, NM (US)

(21) Appl. No.: 19/243,546

(22) Filed: Jun. 19, 2025

Related U.S. Application Data
(60) Provisional application No. 63/662,971, filed on Jun. 21, 2024.

(51) Int. Cl. E21B 43/267; B02C 19/00; E21B 43/26

(52) U.S. Cl. CPC E21B 43/267; B02C 19/0056; E21B 43/2607

(57) ABSTRACT

The present disclosure provides methods and systems for hydraulic fracturing applications and optimization utilizing micro-proppant manufactured adjacent to the wellsite to facilitate its availability. The micro-proppant can be combined with conventional proppant in a slurry and the slurry can be injected into a well during hydraulic fracturing applications.

### RELATED APPLICATIONS

The present application claims priority to U.S. Provisional Patent Application No. 63/662,971 filed Jun. 21, 2024, and titled “Manufacturing Micro-proppant Onsite,” the entire content of which is incorporated herein by reference.

### TECHNICAL FIELD

The present application is directed to methods and systems for manufacturing micro-proppant at a well lease site for use in hydraulic fracturing processes.

### BACKGROUND

Hydraulic fracturing is a method of increasing the flow of oil, gas, or other fluids into a wellbore from the surrounding rock formation. Hydraulic fracturing is often used in shale and tight (or unconventional) formations containing hydrocarbon reservoirs. Hydraulic fracturing involves pumping a fracturing fluid into the wellbore under high pressure such that fractures form in the rock formation surrounding the wellbore through which oil and gas can flow into the wellbore and thus, be recovered. However, after hydraulic fracturing and during recovery, the pressure inside the wellbore, and/or against the fracture walls, becomes lower than the pressure applied through the fracturing fluid while pumping the fracturing treatment. As fractures are formed through high pressure forces, fractures will close due to the leakoff of fracturing fluid into the surrounding rock formation and the stress applied by the surrounding formation.

In order to keep the fractures open and maintain wellbore connectivity and fracture conductivity (i.e., fracture permeability times fracture width) during recovery, proppant is injected into the fractures to prop the fractures open while allowing fluid to flow through its interstitial space. Proppants are commonly mixed into fracturing fluid and injected into the fractures with the fracturing fluid as the fractures are created. Traditionally, proppants are silica sand or manufactured ceramic particulates from raw materials such as kaolin and bauxite.

Proppant particle shape for hydraulic fracturing is described by sphericity and roundness. Proppant particles are generally characterized by a particle size distribution range. It can be advantageous to use proppant with wider particle size distribution for hydraulic fracturing applications in shale and tight reservoirs. However, the smallest grain size of natural sand typically is limited to a size range that is larger than what is required for some hydraulic fracturing applications. In contrast, smaller sized proppant, known as micro-proppant, is more difficult to obtain. One source of micro-proppant is manufactured ceramic proppant, but the cost of manufactured ceramic proppant is significantly higher than conventional-sized sand proppant. Ceramic and non-ceramic micro-proppant options are generally priced much higher than natural sand. Accordingly, a less costly and more readily available source of micro-proppant would be beneficial for hydraulic fracturing operations.

A further challenge associated with all proppant including micro-proppant is the need for the fracturing fluid to deliver it deeper into the fractures in the formation. Physically, only smaller particles can enter a fracture or a portion of it with narrower widths. A low-viscosity fracturing fluid commonly used for hydraulic fracturing in shale and tight reservoirs is known as slickwater. Slickwater typically comprises mostly water with a small amount of chemical additives such as those to reduce friction during the pumping of a hydraulic fracturing treatment. As an example, slickwater typically comprises around or more than 99% water by weight, while the remaining chemicals comprise friction reducing polymer and other additives. Slickwater is extensively utilized for hydraulic fracturing in shale and tight reservoirs due to its cost-effectiveness, minimal damage it causes to formation and proppant pack, and increased fracture surface area. Despite these advantages, slickwater faces a significant challenge in transporting proppant with a concentration of 1 to 2 ppg (pound of proppant per gallon of water) due to its low viscosity. In contrast to more viscous fracturing fluids, the low viscosity of slickwater can be less effective at transporting proppant through the narrow fractures farther away from the wellbore.

### SUMMARY

The present application is generally directed to methods and systems for manufacturing micro-proppant for hydraulic fracturing operations in a production well. In one aspect, a system may comprise: (a) a grinder, (b) a fracturing manifold, (c) a blender, (d) proppant loading equipment, such as a conveyor and hopper, and (e) one or more fracturing pumps, also known as frac pumps or high-pressure pumps. The grinder may be located adjacent to a wellsite, wherein the grinder may crush a first granular material having a particle size of 105 microns to 841 microns to produce a micro-proppant having an average particle size of 3 microns to 88 microns. The grinder may be in communication with the blender first and then with the fracturing manifold, which receives a fracturing slurry comprising: a) the micro-proppant, b) a second granular material having an average particle size of 105 microns to 841 microns, and c) an aqueous fluid. Lastly, the one or more fracturing pumps may pump the fracturing slurry through the fracturing manifold into a wellhead of the wellsite.

In another aspect, a method may comprise crushing, with a grinder located adjacent to a wellsite, a first granular material having an average particle size of 105 microns to 841 microns to produce a micro-proppant having an average particle size of 3 microns to 88 microns. The method may further comprise receiving, at a fracturing manifold in communication with the blender and the grinder, a fracturing slurry comprising: a) the micro-proppant, b) a second granular material having an average particle size of 105 microns to 841 microns, and c) an aqueous fluid. Lastly, the method may additionally comprise pumping, with one or more fracturing pumps, the fracturing slurry from the fracturing manifold into a wellhead of the wellsite.

Yet another aspect of the disclosure is directed to a slurry for a hydraulic fracturing process. The slurry may comprise a micro-proppant, a second granular material, and an aqueous fluid. The micro-proppant may have a P50 between 20 microns and 70 microns and a P10 to P90distribution range between 10 microns and 80 microns, wherein the micro-proppant is formed as a result of crushing a first granular material, and wherein the micro-proppant has reduced sphericity relative to the first granular material. The second granular material may have an average particle size of 105 microns to 841 microns.

The foregoing embodiments are non-limiting examples and other aspects and embodiments will be described herein. The foregoing summary is provided to introduce various concepts in a simplified form that are further described below in the detailed description. This summary is not intended to identify required or essential features of the claimed subject matter nor is the summary intended to limit the scope of the claimed subject matter.

### DESCRIPTION OF THE FIGURES

The drawings illustrate only example embodiments of methods and systems for manufacturing micro-proppant. Therefore, the examples provided are not to be considered limiting of the scope of this disclosure. The principles illustrated in the example embodiments of the drawings can be applied to alternate methods and apparatus. Additionally, the elements and features shown in the drawings are not necessarily to scale, emphasis instead being placed upon clearly illustrating the principles of the example embodiments. Certain dimensions or positions may be exaggerated to help visually convey such principles. In the drawings, the same reference numerals used in different embodiments designate like or corresponding, but not necessarily identical, elements.

FIG. 1 illustrates a schematic diagram of an oilfield system and wellbore treated with hydraulic fracturing techniques, in accordance with certain example embodiments.

FIG. 2 illustrates a hydraulic fracturing system, in accordance with certain example embodiments.

FIG. 3 illustrates a proppant system of a hydraulic fracturing system, in accordance with certain example embodiments.

FIG. 4 illustrates another view of the proppant system of FIG. 3, in accordance with certain example embodiments.

FIG. 5 illustrates another proppant system of a hydraulic fracturing system, in accordance with certain example embodiments.

FIG. 6 illustrates a portion of the proppant system of FIG. 5, in accordance with certain example embodiments.

FIG. 7 illustrates another portion of the proppant system of FIG. 5, in accordance with certain example embodiments.

FIG. 8 illustrates yet another proppant system of a hydraulic fracturing system, in accordance with certain example embodiments.

FIG. 9 illustrates another hydraulic fracturing system, in accordance with certain example embodiments.

FIGS. 10a, 10b, and 10c illustrate a fracture undergoing hydraulic fracturing, in accordance with certain example embodiments.

FIG. 11 illustrates the placement of proppant of varying sizes within a fracture, in accordance with certain example embodiments.

FIG. 12 illustrates particle size distribution data for conventional fracturing silica sand before grinding, in accordance with certain example embodiments.

FIG. 13 illustrates particle size distribution data for conventional fracturing silica sand after dry grinding, in accordance with certain example embodiments.

FIG. 14 illustrates particle size distribution data for conventional fracturing silica sand after wet grinding, in accordance with certain example embodiments.

### DESCRIPTION OF EXAMPLE EMBODIMENTS

Example embodiments discussed herein are directed to systems and methods for manufacturing micro-proppant for use in hydraulic fracturing applications. The example embodiments described herein include manufacturing the micro-proppant at the well lease site to facilitate the availability of the micro-proppant for hydraulic fracturing. The size and the shape of the micro-proppant facilitates placing the micro-proppant deeper into fractures to improve permeability in the fractured formation. In the following paragraphs, particular embodiments will be described in further detail by way of example with reference to the drawings. In the description, well-known components, methods, and/or processing techniques are omitted or briefly described. Furthermore, reference to various feature(s) of the embodiments is not to suggest that all embodiments must include the referenced feature(s).

As introduced above, hydraulic fracturing involves pumping fluid into a formation through a perforated or open-hole interval of a wellbore to create a tensile fracture. Once the fracture is large enough, the pumping is switched from the clean fluid to a mixture of fluid and proppant. Upon completion, when pumping has stopped, the fluid inside the fracture continues leaking off into the permeable formation until the fracture closes on proppant. The objective is to create a highly conductive pathway from the wellbore deep into the formation to improve the flow of hydrocarbons from the formation to the wellbore. The majority of proppant used for hydraulic fracturing is natural sand due to its cost advantage, but other types of proppants, including ceramic proppant, resin-coated proppant (either coating on sand or ceramic proppant particles) and other man-made materials, are also used for high-stress environments or other applications to mitigate proppant bridging and flowback and improve proppant suspension and transport.

Propped fracture surface area (i.e., the fracture surface area covered by proppant) plays a key role in hydraulic fracturing performance for shale and tight reservoirs, and can be improved with a combination of smaller sized proppant (micro-proppant) and conventional proppant. Micro-proppant typically has particle sizes ranging from size 140 mesh (105 microns) to 4800 mesh (3 microns) size. Some commonly used conventional proppant sizes include 12/20, 16/30, 20/40, 30/50, 40/70, and 70/140 mesh by sieve analysis. Conventional proppant is larger than micro-proppant. The approach of combining conventional proppant with micro-proppant facilitates optimal proppant placement within the fracture: the larger conventional-sized proppant particles quickly settle to form a proppant dune, ensuring sufficient fracture conductivity near the wellbore, while the relatively smaller micro-proppant particles travel deeper into the fracture, increasing the proppant-covered fracture surface area in portions of the fracture farther from the wellbore.

The example systems and methods described herein include deploying a grinder at the well lease site to grind a granular material into micro-proppant. Grinding the granular material into the micro-proppant at the well lease site makes the micro-proppant readily available for fracturing applications and avoids the need to transport micro-proppant to the well lease site. Using granular material such as silica sand or drilling cuttings to form the micro-proppant is more cost-effective than manufacturing micro-proppant offsite using more costly materials such as ceramic. Furthermore, as described further below, the physical characteristics of crushed silica sand and drilling cuttings can provide advantages over ceramic micro-proppant. After grinding, the desired micro-proppant particle sizes range from 140 mesh (105 microns) to 4800 mesh (3 microns). The micro-proppant is combined with conventional proppant into a fracturing fluid to create a slurry that is pumped down the wellbore and into the fractures in the formation.

While silica sand and drilling cuttings are referenced again below as examples of granular material that can be ground into micro-proppant, the example embodiments are not limited to these examples. Other examples of granular material that can be ground into micro-proppant include petroleum coke particles, recycled glass particles, diatomite beads, walnut shells, and other inert solid materials. More generally, other inert solid materials may be used as the granular material that is ground into micro-proppant, but such materials should have a specific gravity between 1.0 and 3.2 and a crush resistance or strength of greater than 4,000 psi.

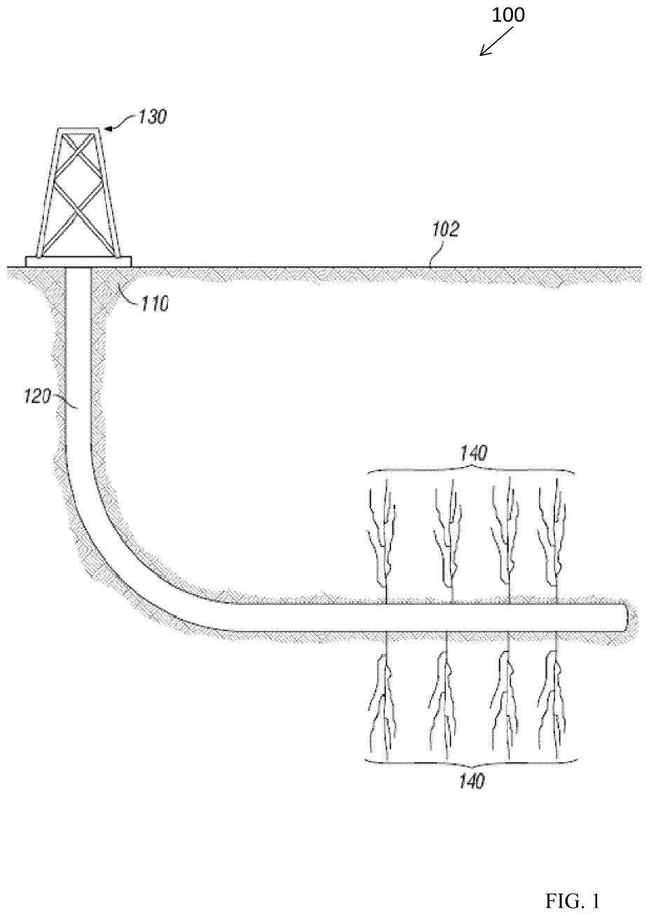

Referring to FIG. 1, an example embodiment of an oilfield system 100 is illustrated. In the oilfield system 100, a wellbore 120 is formed in a subterranean formation 110 using field equipment 130 above a surface 102. For on-shore applications, the surface 102 is ground level. For off-shore applications, the surface 102 is the sea floor or an operational platform such as on the deck of an offshore treatment vessel. The point where the wellbore 120 begins at the surface 102 can be called the entry point. The subterranean formation 110 in which the wellbore 120 is formed includes one or more of a number of formation types, including but not limited to shale, limestone, sandstone, clay, sand, and salt. In certain embodiments, the subterranean formation 110 can also include one or more reservoirs in which one or more resources (e.g., oil, gas, water, or thermal steam) can be located. One or more of a number of field operations (e.g., drilling, setting casing, extracting production fluids) can be performed to reach an objective of a user with respect to the subterranean formation 110. During a drilling operation, excavated bits of the subterranean formation 110, referred to as solid drilling cuttings or simply drilling cuttings, are flushed out of the wellbore 120 and brought to the surface 102 by drilling fluid.

The example oilfield system 100 of FIG. 1 further includes fractures 140 formed through a hydraulic fracturing process. In an example hydraulic fracturing process, a fluid is injected into the wellbore 120 with high enough pressure to create fractures 140 in the surrounding formation 110. Such a process increases the surface area in the formation 110 from which oil and gas can flow. In certain example embodiments, the stimulation fluid contains proppants, which are placed into the fractures and hold the fractures open, allowing oil and gas to flow from the fractures 140 into the wellbore 120 so that it can be recovered.

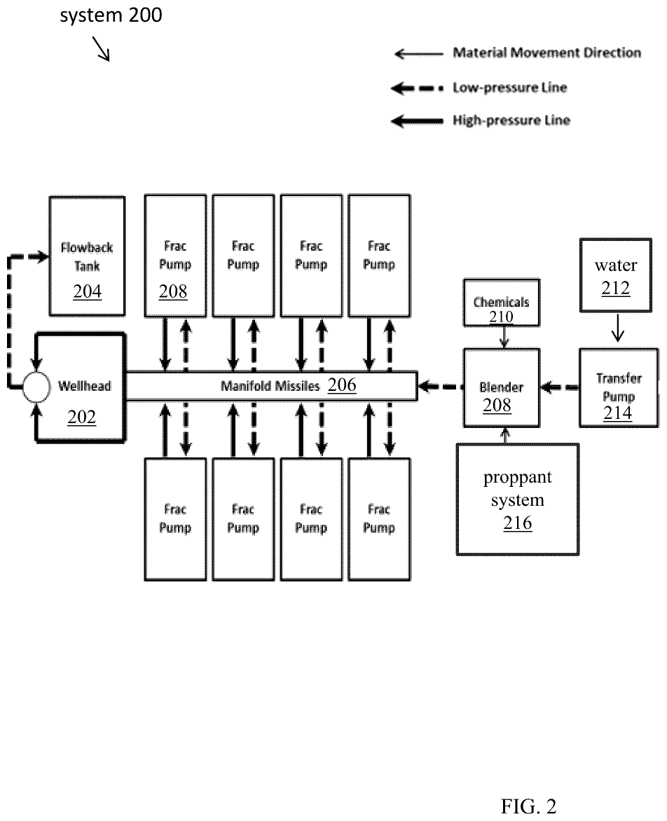

The description that follows will refer to several examples of hydraulic fracturing systems that are illustrated in FIGS. 2-9. The hydraulic fracturing systems illustrated in FIGS. 2-9 and described below are illustrative and should not be interpreted as limiting. In other embodiments, certain components of the systems described below may be modified or omitted. Additionally, components from an example described below may incorporated into or interchanged with components in other examples described below.

FIG. 2 illustrates a system 200 for hydraulic fracturing, in accordance with example embodiments of the present disclosure. The system 200 may be located at the surface 102 and be combined with or adjacent to the field equipment 130 shown in FIG. 1. As illustrated in FIG. 2, a hydraulic fracturing operation includes an array of equipment positioned adjacent to a wellhead 202 of a wellbore, such as wellbore 120 of FIG. 1. The system 200 includes a blender 208 that receives water 212 from a transfer pump 214. Optionally, the blender may also receive various chemicals 210, such as friction reducing additives, which facilitate the hydraulic fracturing operation. The water and chemicals are combined in the blender 208 to form a fracturing fluid. The blender 208 also combines proppant, from a proppant system 216, with the fracturing fluid to form a slurry. The blender 208 directs the slurry via a low-pressure line to a fracturing manifold 206, which in turn feeds the slurry into one or more fracturing pumps 208. The fracturing pumps 208 pressurize the slurry and return the pressurized slurry via one or more high pressure lines to the fracturing manifold 206. The manifold directs the pressurized slurry into the wellhead 202 where it flows down the wellbore, through perforated or open-hole interval(s) and into the formation that is being fractured. After fracturing, the proppant is designed to stay inside the fracture but most of the fluid, sometimes containing a certain amount of proppant, the latter of which is not by design, is returned from the formation to the wellbore are stored in a flowback tank 204 (or a pit).

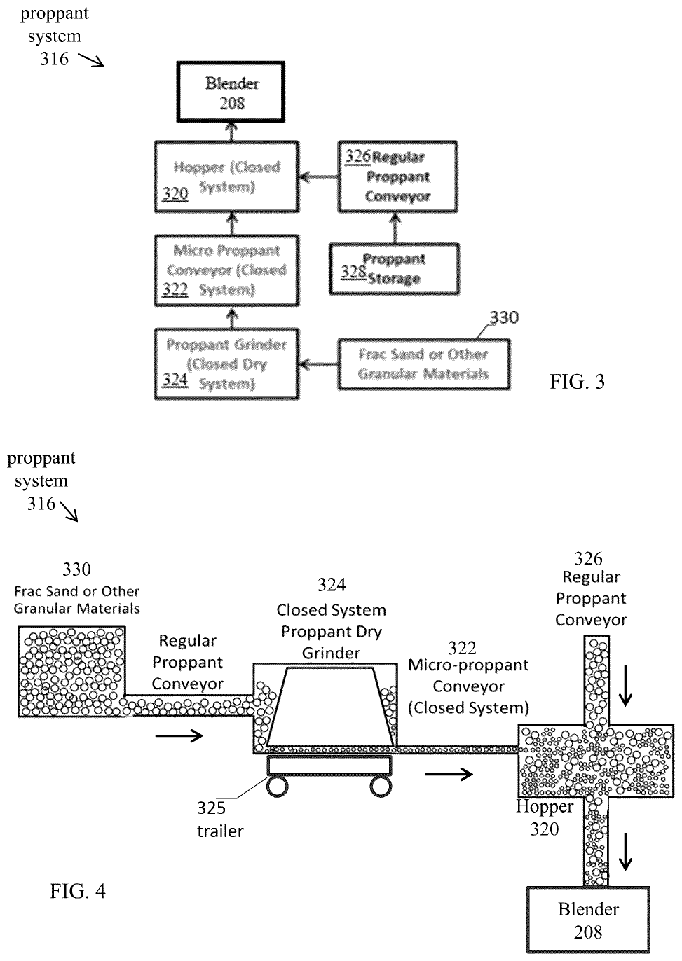

An example of proppant system 216 is illustrated in greater detail as proppant system 316 in FIGS. 3 and 4. As shown in FIGS. 3 and 4, granular material 330 may be conventional fracturing sand or other material such as drilling cuttings. In certain examples, the granular material may be a combination of silica sand and drilling cuttings. Before use as a granular material for proppant, the drilling cuttings may undergo removal of drilling fluid from the drilling cuttings. Granular material 330 has an average particle size of 105 microns to 841 microns, which is the typical size for commonly used conventional fracturing proppant materials. The granular material 330 is fed into grinder 324. Grinder 324 can be any of a variety of grinders, such as a ball mill grinder, which are suitable for crushing granular material such as silica sand or drilling cuttings. The grinder 324 of proppant system 316 is a dry grinder. A challenge associated with dry grinders is that they produce a substantial amount of fine dust that can be hazardous to personnel and machinery. Therefore, grinder 324 is placed within a closed system that seals the grinder 324 and contains the dust generated by the grinding process.

The grinder 324 crushes the granular material 330 into a micro-proppant having an average particle size of 3 microns to 88 microns. The smaller average size of the micro-proppant particles will be advantageous for providing a proppant with a range of sizes that can more effectively maintain permeability within fractures in a formation. The micro-proppant travels within a micro-proppant conveyor 322 from the grinder 324 to a hopper 320. The micro-proppant conveyor 322 also is a closed system to contain any dust produced from the grinding process.

In the example of proppant system 316, conventional sized proppant is handled in a work stream in parallel to the work stream that produces the micro-proppant. Specifically, a granular material suitable for use as conventional sized proppant, having a particle size in the range of 105 microns to 841 microns, is stored in storage area 328. The conventional (regular) granular material stored in storage area 328 may be the same granular material 330 that is used to create the micro-proppant or it may be a different material. As examples, the conventional granular material in storage area 328 may be silica sand or drilling cuttings. Where the granular materials for each work stream are the same, the two sources of granular material shown in FIGS. 3 and 4 may be combined into a single storage container.

The conventional granular material in storage area 328 is fed into proppant conveyor 326, which directs the conventional granular material into hopper 320. In hopper 320, the conventional granular material will begin to mix with the micro-proppant. The mixture of the conventional granular material and the micro-proppant is fed from the hopper 320 to the blender 208 where it is further mixed with the fracturing fluid.

As illustrated in FIG. 4, the grinder 324 can be configured so that it is mobile. In the example of FIG. 4, the grinder 324 is positioned on a trailer 325 so that it can be moved easily to and from the well lease site. One or more of the conveyors can also be placed on trailer 325. Placing the grinder 324 on a mobile trailer facilitates the production of the micro-proppant at the well lease site and avoids the costs and challenges of transporting micro-proppant from other locations. Configuring the grinder to be mobile also supports scaling up the solution so that micro-proppant can be easily manufactured at many well lease sites involving hydraulic fracturing operations.

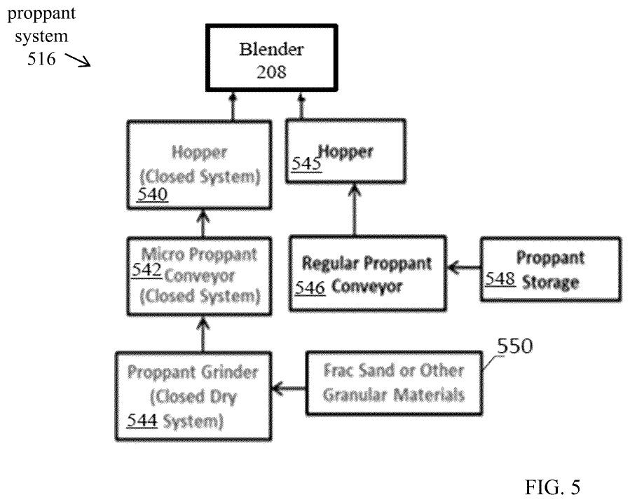

Referring now to FIGS. 5-7, another example of proppant system 216 is illustrated in greater detail as proppant system 516. As illustrated in FIGS. 5-7, granular material 550 may be conventional fracturing sand or other material such as drilling cuttings. Granular material 550 has a particle size of 105 microns to 841 microns, which is a typical size for commonly used conventional fracturing proppant material. The granular material 550 is fed into grinder 544. Grinder 544 can be any of a variety of grinders, such as a ball mill grinder, which are suitable for crushing granular material such as silica sand or drilling cuttings. The grinder 544 of proppant system 516 is a dry grinder. Similar to the grinder of FIGS. 3 and 4, grinder 544 is placed within a closed system that seals the grinder 544 and contains the dust generated by the grinding process. Although not illustrated in FIG. 5, the grinder 544 can be configured so that it is mobile in a manner similar to the arrangement in FIG. 4.

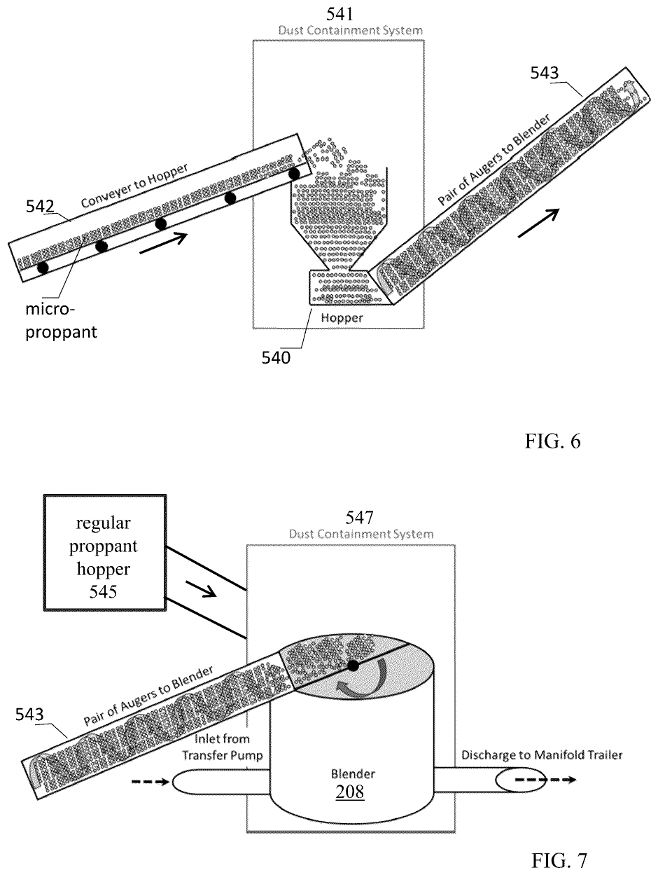

The grinder 544 crushes the granular material 550 into a micro-proppant having an average particle size of 3 microns to 88 microns. The smaller average size of the micro-proppant particles will be advantageous for providing a proppant with a range of sizes that can more effectively maintain permeability within fractures in a formation. The micro-proppant travels within a micro-proppant conveyor 542 from the grinder 544 to a micro-proppant hopper 540. FIG. 6 illustrates the micro-proppant conveyor 542 and micro-proppant hopper 540 in greater detail. FIG. 6 also illustrates an example device in the form of an auger conveyor 543 for transporting the micro-proppant from the micro-proppant hopper 540 to the blender 208. The micro-proppant conveyor 542, the micro-proppant hopper 540, and the auger conveyor 543 are placed in a closed dust containment system 541 to contain any dust produced from the grinding process.

In the example of proppant system 516, conventional sized proppant is handled in a work stream in parallel to the work stream that produces the micro-proppant. Specifically, a granular material suitable for use as conventional sized proppant, having an average particle size in the range of 105 microns to 841 microns, is stored in storage area 548. The conventional (regular) granular material stored in storage area 548 may be the same granular material 550 that is used to create the micro-proppant, or it may be a different material. As examples, the conventional granular material in storage container 548 may be silica sand or drilling cuttings. Where the granular materials for each work stream are the same, the two sources of granular material shown in FIG. 5 may be combined into a single storage container.

The conventional granular material in storage container 548 is fed into proppant conveyor 546, which directs the conventional granular material into hopper 545. As illustrated in greater detail in FIG. 7, the conventional granular material and the micro-proppant are received at the blender 208 as independent feeds and they are mixed by the blender with fracturing fluid to form the slurry that is delivered to the fracturing manifold 206. As further illustrated in FIG. 7, the blender 208 is placed within a closed dust containment system 547 to contain any dust produced from the grinding process.

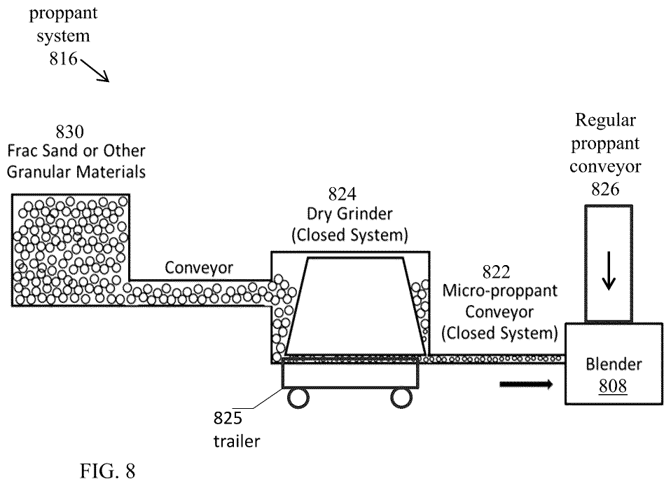

Referring now to FIG. 8, another proppant system 816 is illustrated. Proppant system 816 is similar to proppant system 516, except that it eliminates the use of hoppers for the micro-proppant. As shown in FIG. 8, granular material 830 may be conventional fracturing sand or other material such as drilling cuttings. Granular material 830 has an average particle size of 105 microns to 841 microns, which is a typical size for conventional fracturing proppant material. The granular material 830 is fed into grinder 824. Grinder 824 can be any of a variety of grinders, such as a ball mill grinder, which are suitable for crushing granular material such as silica sand or drilling cuttings. The grinder 824 of proppant system 816 is a dry grinder. Similar to the grinders of FIGS. 3-5, grinder 824 is placed within a closed system that seals the grinder 824 and contains the dust generated by the grinding process. Additionally, grinder 824 can be placed on a trailer 825 as illustrated in FIG. 8 to facilitate creating the micro-proppant at the at the well lease site.

After grinding the granular material 830 into micro-proppant, a micro-proppant conveyor 822 transports the micro-proppant to a blender 808. The blender also receives conventional (regular) proppant via conveyor 826. As in the previously described systems, the blender 808 combines the conventional proppant, the micro-proppant, and fracturing fluid to form the slurry that is injected into a wellbore in a hydraulic fracturing application.

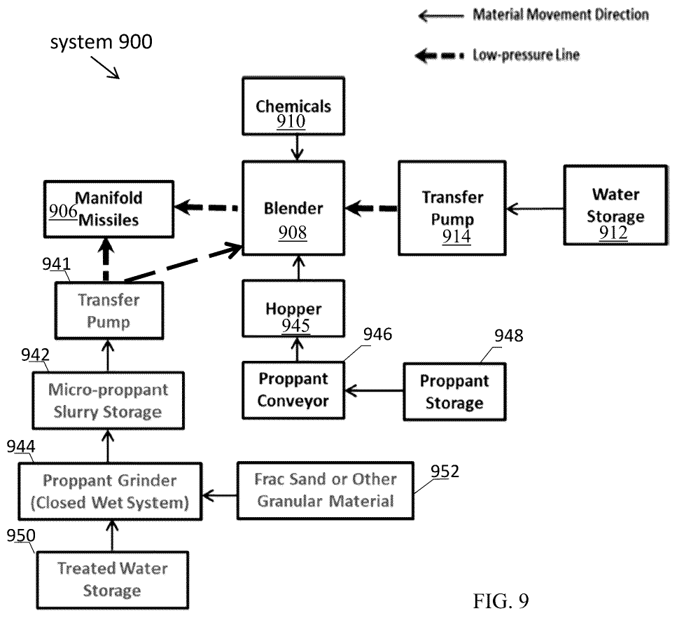

Referring now to FIG. 9, an alternative hydraulic fracturing system 900 that employs a wet grinding process is illustrated. Several aspects of the system 900 are similar to aspects of the previously described systems. Hydraulic fracturing system 900 includes equipment that can be positioned adjacent to a wellhead of a wellbore. The system 200 includes a blender 908 that receives water 912 from a transfer pump 914. Optionally, the blender may also receive various chemicals 910, such as friction reducing additives, which facilitate the hydraulic fracturing operation. The water and optional chemicals are combined in the blender 908 to form a fracturing fluid. The blender 908 also combines proppant with the fracturing fluid to form a slurry. The blender 908 directs the slurry via a low-pressure line to a fracturing manifold 906. Although not shown in FIG. 9, similar to the system of FIG. 2, one or more fracturing pumps receive the slurry from the fracturing manifold 906, pressurize the slurry, and return the pressurized slurry via one or more high pressure lines to the fracturing manifold 906. The fracturing manifold 906 directs the pressurized slurry into a wellhead where it flows down the wellbore and into the formation that is being fractured.

The proppant system of FIG. 9 includes components similar to those described previously in connection with FIGS. 3-8. Granular material 952 may be conventional fracturing sand or other material such as drilling cuttings. Granular material 952 has an average particle size of 105 microns to 841 microns, which is a typical size for conventional fracturing proppant material. The granular material 952 is fed into grinder 944.

In contrast to the previously described dry grinding processes, grinder 944 is a wet grinder. An advantage of wet grinding is that it mitigates the dust created during the grinding. In addition to the granular material 952, a grinding fluid 950 is fed into the grinder and mixed with the granular material 952. In the example of FIG. 9, the grinding fluid is treated water, such as gelled water. While the wet grinding process mitigates dust, the grinder 944 is preferably placed within a closed system to contain any dust from the loading of the granular material into the grinder or any dust created during grinding. Additionally, although not illustrated in FIG. 9, the grinder 944 can be configured so that it is mobile in a manner similar to the arrangement in FIG. 4.

An example of grinder 944 for wet grinding is a horizontal stirred media mill. A horizontal stirred media mill incorporates internal particle size classification and recirculation, thereby eliminating the need for external classification circuits. This integrated design enables precise control over particle size distribution, which mitigates overgrinding, reduces equipment wear, and lowers energy consumption. Furthermore, horizontal stirred media mills are highly scalable, allowing for customization to meet specific throughput and mobility requirements, making them especially suitable for onsite micro-proppant production.

In an example embodiment, the granular material 952 has an 80% passing size of approximately 400 microns when it is fed into the grinder 944. The grinder 944 crushes the granular material 952 into a micro-proppant having an average particle size of 3 microns to 105 microns. Preferably, the micro-proppant has an 80% passing size of 50 microns. The smaller average size of the micro-proppant particles will be advantageous for providing a proppant with a range of sizes that can more effectively maintain permeability within fractures in a formation.

In an example embodiment, the grinder 944 is designed to achieve a throughput of up to 30 tons per hour. A mobile, horizontal stirred media mill capable of delivering this throughput at a size reduction ratio of 8:1 (400 microns to 50 microns) would require an internal volume in the range of approximately 1,000 to 1,500 liters (265 to 396 gallons).

In an example embodiment, the granular material 952 may be fed to the grinder 944 in either a dry form or as a slurry. Within the grinder 944, the granular material 952 is mixed with grinding fluid, such as treated water, to achieve a pulp density of 20-40% solids by weight, and chemical additives may be introduced to adjust the pH and viscosity. The resulting slurry is then pumped into the grinding apparatus of the grinder, such as the previously described horizontal stirred media mill designed to process 30 tons per hour. The mixture of micro-proppant and treated water processed by the grinder may be placed into a thickener tank, where excess water is removed and treated for reuse. After removing the excess water, the resulting micro-proppant slurry is stored in a micro-proppant slurry storage tank 942 before being mixed with conventional proppant in the blender or combined with the conventional proppant slurry in the low-pressure line after the blender discharge.

In the example of hydraulic fracturing system 900, conventional sized proppant is handled in a work stream in parallel to the work stream that produces the micro-proppant. Specifically, a granular material suitable for use as conventional sized proppant, having an average particle size in the range of 105 microns to 841 microns, is stored in storage area 948. The conventional granular material stored in storage area 948 may be the same granular material 952 that is used to create the micro-proppant, or it may be a different material. As examples, the conventional granular material in storage area 948 may be silica sand or drilling cuttings. Where the granular materials for each work stream are the same, the two sources of granular material shown in FIG. 9 may be combined into a single storage area or container. The conventional granular material in storage area 948 is fed into proppant conveyor 946, which directs the conventional granular material into hopper 945, and subsequently into blender 908.

The hydraulic fracturing system 900 of FIG. 9 presents two options for combining the micro-proppant and the conventional granular material. In a first option, a transfer pump 941 pumps the micro-proppant slurry into the blender 908 where the micro-proppant slurry is mixed with the conventional granular material as well as water 912 and optional chemicals 910 to form the fracturing slurry. The blender 908 then pumps the fracturing slurry via a low-pressure line to the fracturing manifold 906 for pressurizing the fracturing slurry before delivery to the wellbore and the formation to be fractured.

As a second option, the transfer pump 941 pumps the micro-proppant slurry directly into the fracturing manifold 906. Within the fracturing manifold 906, the micro-proppant slurry will be combined with the conventional granular material, water 912, and optional chemicals 910 to form the fracturing slurry. The fracturing pumps 208 will pressurize the fracturing slurry from the fracturing manifold 906 before delivering the pressurized fracturing slurry to the wellbore and the formation to be fractured.

One of the advantages of the foregoing hydraulic fracturing systems is that they provide greater availability of micro-proppant at the well lease site. The current practice in the industry is to pump commercial ceramic micro-proppant as only a few percents of the total sand quantity pumped per stage. This current practice is due to cost considerations as ceramic micro-proppant costs around 25 to 30 times more than conventional fracturing sand. However, increasing the amount of micro-proppant in the fracturing slurry would allow for more comprehensive propping of the vast, narrow fracture networks that form in shale and tight formations. In certain example embodiments, increasing the amount of micro-proppant to 2.5% to 25% of the total proppant of a fracturing slurry used in a fracturing operation would greatly enhance production from a shale and tight formation. Providing grinding to produce micro-proppant at the well lease site can make the application of increased amounts of micro-proppant feasible.

Increased use of micro-proppant in hydraulic fracturing can provide several advantages. As one example, the benefit of a proppant slurry including micro-proppant with a wider particle size distribution can improve proppant placement inside and along the length of the fracture and thereby enhance production from the reservoir. This improved proppant placement along the length of a fracture also can mitigate undesirable fracturing hits or fracture driven interactions (FDIs) that can occur between distinct fractures. Furthermore, micro-proppant can be effective to reduce proppant-entry friction in the near-wellbore area and allow a dominant fracture to propagate from each perforation cluster.

Other advantages of the foregoing embodiments relate to the physical characteristics of the micro-proppant produced by the onsite grinding processes described herein. In one aspect, conventional proppant used in hydraulic fracturing tend to be more spherical than the onsite produced micro-proppant. Grinding silica sand particles as described herein produces micro-proppant particles having a more irregular shape with reduced sphericity when compared to the shape of conventional silica sand proppant. The reduced sphericity of the micro-proppant particles creates greater surface area per unit of mass, thereby causing the fracturing fluid to apply more drag forces and push the micro-proppant farther into the narrower sections of the fracture. Accordingly, the reduced sphericity of the micro-proppant can result in a greater surface area of the fracture being propped open for production of hydrocarbons. Additionally, the jagged shape of the micro-proppant promotes the formation of proppant pillars in the deeper sections of a hydraulic fracture farther from the wellbore.

In another aspect, micro-proppant created from silica sand is less dense than micro-proppant manufactured from ceramic material. The specific gravity of silica sand is approximately 2.65, whereas the specific gravity of typical ceramic proppant is approximately 3.2. Accordingly, the less dense silica sand micro-proppant can be carried more evenly in the fracturing slurry and transported farther into the fracture when compared to ceramic micro-proppant. Accordingly, the density of the silica micro-proppant described herein also results in improved placement of proppant in the deeper sections of the fractures in the formation farther from the wellbore and improved production of hydrocarbons.

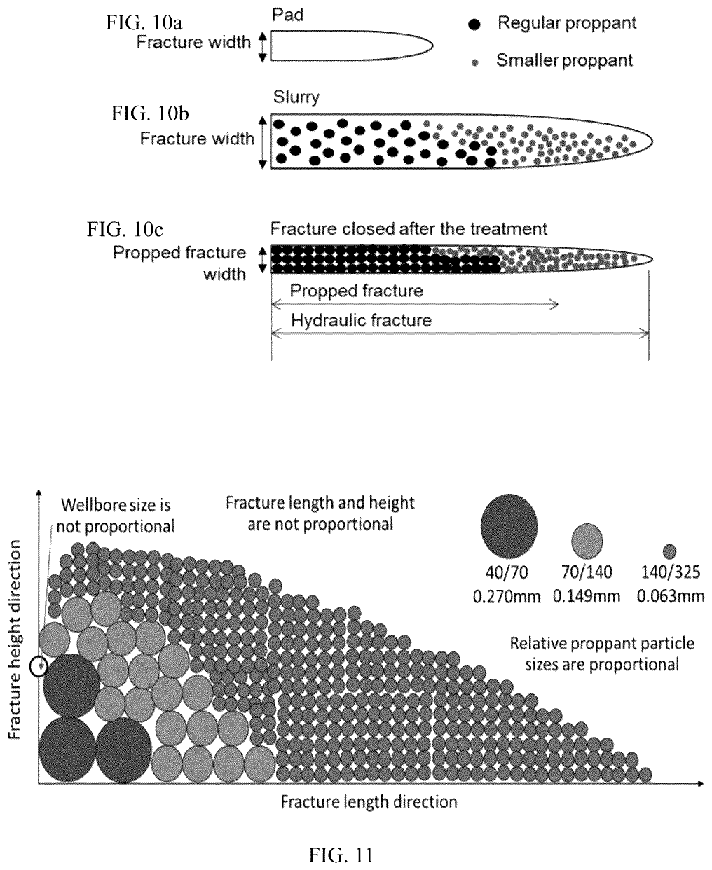

Referring now to FIGS. 10a, 10b, and 10c, a hydraulic fracturing treatment will be described in further detail. During a hydraulic fracturing treatment, the initial fracturing fluid, which is referred to as pad fluid or clean fluid, is pumped without any proppant. Once the desired fracture dimensions (especially the fracture width) are achieved with the pad fluid, the pumping is switched from a pad fluid to a mixture of fluid and proppant, which is referred to as proppant slurry or fracturing slurry. The fracturing slurry begins with pumping lower concentrations of smaller-sized or regular-sized proppant to avoid plugging the fracture or screenout with too much proppant. A general rule is that the proppant cannot travel far away from the wellbore if the ratio of the fracture width to the proppant size is less than 3 and can travel more freely and deeper into the fracture system if the ratio is equal to or larger than 6. As the fracture grows wider and larger, the proppant concentration is increased gradually to meet the design requirement and ensure successful proppant placement and fracture treatment.

FIGS. 10a, 10b, and 10c illustrate fracture propagation and proppant placement with two different particle sizes in the fracture width and length dimensions. FIGS. 10a illustrates the initial phase of treatment during which pad fluid is pumped and the fracture begins to form. As the treatment progresses and fracturing slurry containing proppant is introduced, the fracture increases in FIG. 10b. FIG. 10c illustrates the fracture after fluid pumping has stopped and the proppant are maintaining the fracture in an open state so that hydrocarbons can flow along the fracture. As illustrated in these figures, micro-proppant can be transported more easily within and can reach deeper into the fracture, thereby improving proppant placement. Additionally, these figures indicate that increased use of micro-proppant can significantly reduce the pad fluid volume, and the overall fracturing fluid volume required to complete a hydraulic fracturing treatment.

Referring now to FIG. 11, the figure illustrates proppant placement with three different particle sizes in the fracture length and height dimensions. The smallest particle size in FIG. 11 represents the mean size of the micro-proppant described herein. Computational fluid dynamics modeling studies show that micro-proppant can be placed to a greater extent in both the fracture height and length directions. Complex fracture networks are often created during hydraulic fracturing in shale and tight reservoirs. Micro-proppant, especially the smallest proppant particles, can also travel into the secondary and tertiary fractures within the complex fracture network, though the network with primary, secondary, and tertiary fractures is not shown in this figure.

### Example Testing

Material characterization and grinding studies were conducted to demonstrate and optimize processes for creating micro-proppant by way of a grinding process which can be appropriately scaled for applications at a well lease site. In these tests, conventional fracturing silica sand having a particle size range of 100 to 400 microns was processed in a ball mill grinder for periods of up to 3 hours to significantly reduce the particle sizes down to a desired micro-proppant size range of approximately 10 to 100 microns. The testing was conducted with both dry and wet grinding. Generally, wet grinding tends to require lower energy consumption and tends to produce a narrower distribution of smaller particle sizes. Laser particle size analysis, X-ray diffraction (XRD), and scanning electron microscope (SEM) analyses were used to characterize materials pre-and post-grinding.

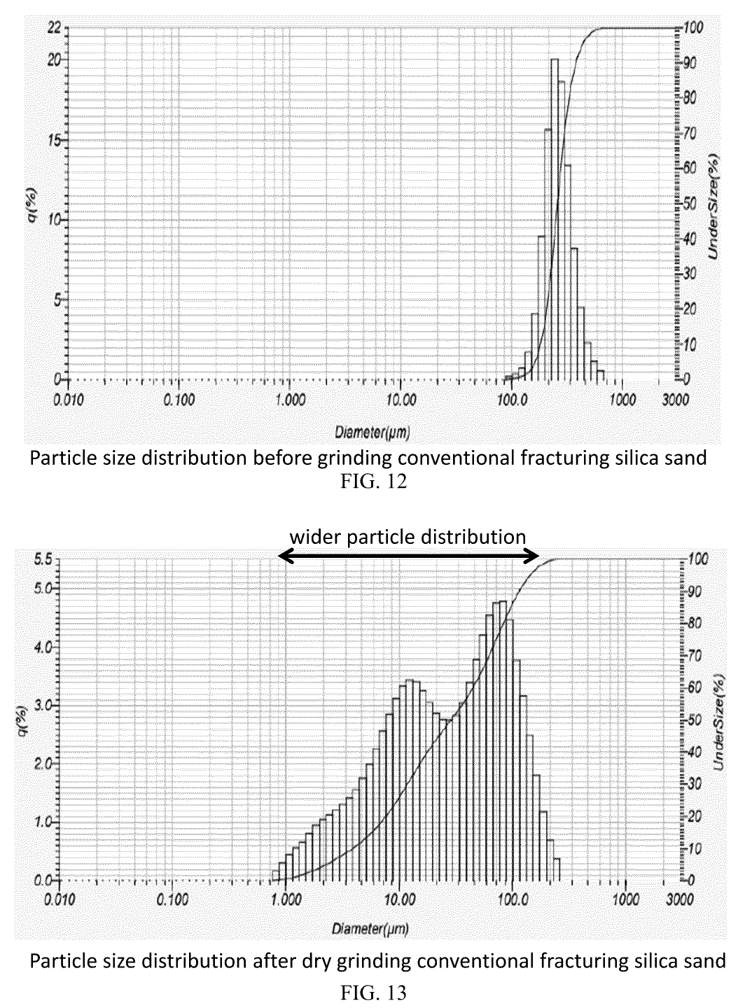

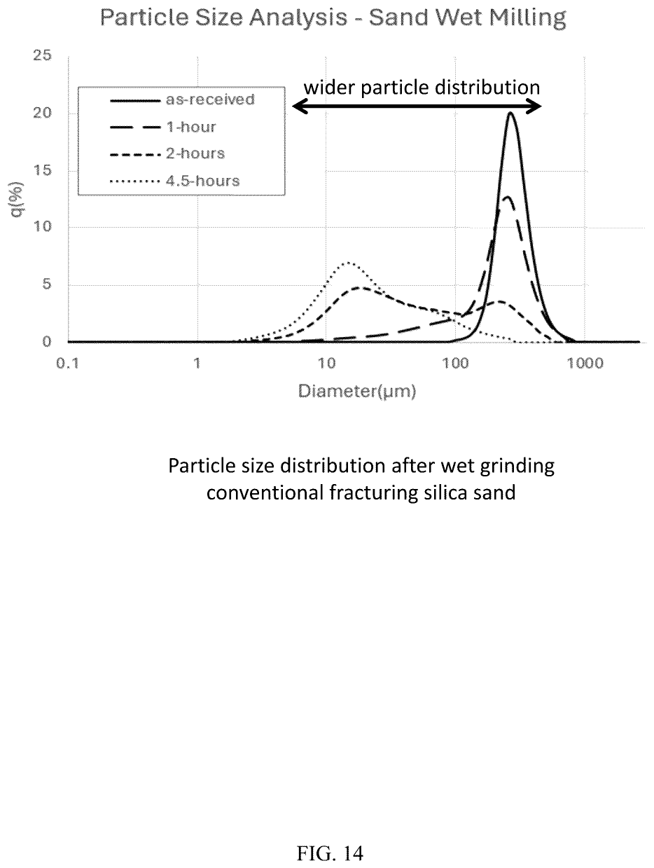

Results from the testing are illustrated in FIGS. 12 and 13. FIG. 12 shows the particle size distribution for a conventional fracturing silica sand prior to grinding. The particle size distribution in FIG. 12 is relatively narrow and ranges from approximately 100 to 400 microns. FIG. 13 illustrates the post-grinding micro-proppant particle size distribution achieved through dry grinding of the conventional fracturing silica sand referenced in FIG. 12. The post-grinding micro-proppant particle size distribution in FIG. 13 ranges from approximately 1 micron to 200 microns with clusters around 10 microns and 100 microns. In addition to the desired smaller size of the micro-proppant in FIG. 13, the distribution is wider, and the majority of the particles are in the 10 microns to 100 microns range. FIG. 14 illustrates the post-grinding micro-proppant particle size distribution achieved through wet grinding of the conventional fracturing silica in water. The more even distribution of the micro-proppant illustrated in FIGS. 13 and 14 is advantageous for obtaining a more even distribution of micro-proppant in the fractures in a formation. As demonstrated by FIGS. 13 and 14, the duration of the grinding process can be adjusted (among other variables) to tune the output particle size distribution for a material. The more even distribution of the micro-proppant illustrated in FIGS. 13 and 14 can be described using the P90/P10 ratio. A P90/P10 ratio of between 10 and 50 indicates a more even distribution that is desirable for micro-proppant. As understood by those of skill in this field, P50 indicates the particle size below which 50% of the sample weight exists. Similarly, P10 indicates the particle size below which 10% of the sample weight exists and P90 indicates the particle size below which 90% of the sample weight exists.

### Assumptions and Definitions

With respect to the example methods described herein, it should be understood that in alternate embodiments, certain steps of the methods may be combined, may be performed in a different order, may be performed in parallel, or may be omitted. Moreover, in alternate embodiments additional steps may be added to the example methods described herein. Accordingly, the example methods provided herein should be viewed as illustrative and not limiting the disclosure.

With respect to the apparatus illustrated and described herein, it should be understood that one or more of the components may be omitted, added, repeated, and/or substituted. Accordingly, embodiments described herein or shown in a particular figure should not be considered limited to the specific arrangements of components shown in such figure. Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure.

The terms “a,” “an,” and “the” are intended to include plural alternatives, e.g., at least one. The terms “including”, “with”, and “having”, as used herein, are defined as comprising (i.e., open language), unless specified otherwise.

Various numerical ranges are disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. Numerical end points of ranges disclosed herein are approximate, unless excluded by proviso.

Values, ranges, or features may be expressed herein as “about”, from “about” one particular value, and/or to “about” another particular value. When such values, or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means ±20% of the stated value, ±15% of the stated value, ±10% of the stated value, ±5% of the stated value, ±3% of the stated value, or ±1% of the stated value.

The term “well lease site” as used herein refers to the area immediately surrounding a well and the adjacent area.

As explained above, the hydraulic fracturing systems described herein may be used in shale and tight formations, as well as other “unconventional formations” having nanodarcy to millidarcy permeability. As used herein, an “unconventional formation” is a subterranean hydrocarbon-bearing formation that generally requires intervention in order to recover hydrocarbons from the reservoir at economic flow rates or volumes. For example, an unconventional formation includes reservoirs having an unconventional microstructure in which fractures are used to recover hydrocarbons from the reservoir at sufficient flow rates or volumes (e.g., an unconventional reservoir generally needs to be fractured under pressure or have naturally occurring fractures in order to recover hydrocarbons from the reservoir at sufficient flow rates or volumes).

In some embodiments, the unconventional formation can include a reservoir having a system permeability of less than 0.1 millidarcy (mD) (e.g., 0.05 mD or less, 0.01 mD or less, 0.005 mD or less, 0.001 mD or less, 0.0005 mD or less, 0.0001 mD or less, 0.00005 mD or less, 0.00001 mD or less, 0.000005 mD or less, 0.000001 mD or less, or less). In some embodiments, the unconventional formation can include a reservoir having a system permeability of at least 0.000001 mD (e.g., at least 0.000005 mD, at least 0.00001 mD, 0.00005 mD, at least 0.0001 mD, 0.0005 mD, 0.001 mD, at least 0.005 mD, at least 0.01 mD, at least 0.05 mD, at least 0.1 mD).

The unconventional formation can include a reservoir having a system permeability ranging from any of the minimum values described above to any of the maximum values described above. For example, in some embodiments, the unconventional formation can include a reservoir having a permeability of from 0.000001 mD to 0.1 mD (e.g., from 0.001 mD to 25 mD, from 0.001 mD to 10 mD, from 0.01 mD to 10 mD, from 0.1 mD). When referring to a permeability value of a formation, the permeability value can comprise an average value for the permeability of samples across a region of the formation.

The formation may include faults, fractures (e.g., naturally occurring fractures, fractures created through hydraulic fracturing, etc.), etc. The formation may be onshore, offshore (e.g., shallow water, deep water, etc.), etc. Furthermore, the formation may include hydrocarbons, such as liquid hydrocarbons (also known as oil), gas hydrocarbons, a combination of liquid hydrocarbons and gas hydrocarbons (e.g., including gas condensate), etc.

The term formation may be used synonymously with the term “reservoir” or “subsurface reservoir” or “subsurface region of interest” or “subsurface formation” or “subsurface volume of interest” or “subterranean formation”. For example, in some embodiments, the reservoir may be, but is not limited to, a shale and tight reservoir, etc. Indeed, the terms “formation” and the like are not limited to any description or configuration described herein.

Although embodiments described herein are made with reference to example embodiments, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A system comprising:
a grinder located adjacent to a wellsite, wherein the grinder crushes a first granular material having a particle size of 105 microns to 841 microns to produce a micro-proppant having an average particle size of 3 microns to 88 microns;
a fracturing manifold in communication with the grinder, wherein the fracturing manifold receives a fracturing slurry comprising: a) the micro-proppant, b) a second granular material having an average particle size of 105 microns to 841 microns, and c) an aqueous fluid; and
one or more fracturing pumps that pump the fracturing slurry from the fracturing manifold into a wellhead of the wellsite.

2. The system of claim 1, wherein a majority of the micro-proppant has a reduced sphericity relative to a sphericity of the first granular material as a result of the crushing by the grinder.

3. The system of claim 2, wherein the micro-proppant has a P50 between 20 microns and 70 microns and has a P10 to P90 distribution range between 10 microns and 80 microns.

4. The system of claim 3, wherein the fracturing slurry pumped during a fracturing operation comprises a total volume of proppant, wherein the total volume of proppant comprises the micro-proppant and the second granular material that are pumped during the fracturing operation, and wherein the micro-proppant is 2.5% to 25% of the total volume of proppant pumped during the fracturing operation.

5. The system of claim 1, wherein the first granular material comprises one or more of silica sand, drilling cuttings, petroleum coke particles, recycled glass particles, plastic particles, diatomite beads, walnut shells, and other inert solid materials.

6. The system of claim 1, wherein the second granular material comprises one or more of silica sand, ceramic or other proppant, and drilling cuttings.

7. The system of claim 1, wherein the grinder is located on a mobile trailer adjacent to the wellsite.

8. The system of claim 1, wherein the first granular material is combined with a grinding fluid before the grinder crushes the first granular material.

9. The system of claim 1, wherein the grinder is located within a dust containment system.

10. A method of hydraulic fracturing, the method comprising:
crushing, with a grinder located adjacent to a wellsite, a first granular material having an average particle size of 105 microns to 841 microns to produce a micro-proppant having an average particle size of 3 microns to 88 microns;
receiving, at a fracturing manifold in communication with the grinder, a fracturing slurry comprising: a) the micro-proppant, b) a second granular material having an average particle size of 105 microns to 841 microns, and c) an aqueous fluid; and
pumping, with one or more fracturing pumps, the fracturing slurry from the fracturing manifold into a wellhead of the wellsite.

11. The method of claim 10, wherein a majority of the micro-proppant has a reduced sphericity relative to a sphericity of the first granular material as a result of the crushing by the grinder.

12. The method of claim 11, wherein the micro-proppant has a P50 between 20 microns and 70 microns and a P10 to P90 distribution range between 10 microns and 80 microns.

13. The method of claim 12, wherein the fracturing slurry pumped during a fracturing operation comprises a total volume of proppant, wherein the total volume of proppant comprises the micro-proppant and the second granular material that are pumped during the fracturing operation, and wherein the micro-proppant is 2.5% to 25% of the total volume of proppant pumped during the fracturing operation.

14. The method of claim 10, wherein the first granular material comprises one or more of silica sand, drilling cuttings, petroleum coke particles, recycled glass particles, plastic particles, diatomite beads, walnut shells, and other inert solid materials.

15. The method of claim 10, wherein the second granular material comprises one or more of silica sand, ceramic or other proppant, and drilling cuttings.

16. The method of claim 10, wherein the grinder is located on a mobile trailer adjacent to the wellsite.

17. The method of claim 10, wherein the first granular material is combined with a grinding fluid before the grinder crushes the first granular material.

18. The method of claim 10, wherein the grinder is located within a dust containment system.

19. A slurry for a hydraulic fracturing process, the slurry comprising:
a micro-proppant having a P50 between 20 microns and 70 microns, a P10 to P90 distribution range between 10 microns and 80 microns, wherein the micro-proppant is formed as a result of crushing a first granular material, and wherein the micro-proppant has reduced sphericity relative to the first granular material;
a second granular material having an average particle size of 105 microns to 841 microns; and
an aqueous fluid.

20. The slurry of claim 19, wherein the micro-proppant comprises one or more of crushed silica sand, crushed drilling cuttings, crushed petroleum coke particles, crushed recycled glass particles, crushed plastic particles, crushed diatomite beads, crushed walnut shells, and other inert solid materials.
